(19) United States
(12) Patent Application Publication
(10) Pub. No.: US 2013/0014881 A1
(43) Pub. Date: Jan. 17, 2013

(54) Biaxial Drive Mechanism, Die Bonder and Die Bonder Operating Method

(71) Applicants: Shingo FUKASAWA, Kumagaya (JP); Koji Hosaka, Kumagaya (JP)

(72) Inventors: Shingo FUKASAWA, Kumagaya (JP); Koji Hosaka, Kumagaya (JP)

(73) Assignee: Hitachi High-Tech Instruments Co., Ltd., Kumagaya-shi (JP)

(21) Appl. No.: 13/226,138

(22) Filed: Sep. 6, 2011

(30) Foreign Application Priority Data
Jul. 15, 2011 (JP) 2011-156661

(51) Int. Cl. B32B 37/00; G05B 9/02; B32B 37/12

(52) U.S. Cl. 156/60; 156/349; 156/538; 318/563

(57) ABSTRACT

A highly reliable biaxial drive mechanism and a die bonder operating method capable of preventing fall of an elevation axis of a linear motor upon loss of power are disclosed. The biaxial drive mechanism includes a handling part; a biaxial drive axes provided with a first linear motor unit having a first movable part that moves up and down the handling part along a first linear guide and a first stationary part, and a second linear motor unit having a second movable part that moves the handling part in a horizontal direction vertical to a direction of up and down movement and a second stationary part; a main power source that supplies a power source to the biaxial drive axes; and an elevation axis fall prevention unit that prevents fall of a handling part upon loss of power at the main power source.

### BACKGROUND OF THE INVENTION

The present invention relates to a biaxial drive mechanism including an elevation axis and a die bonder using the biaxial drive mechanism and a die bonder operating method, and more particularly, to a highly reliable biaxial drive mechanism including an elevation axis and a highly reliable die bonder using the biaxial drive mechanism and a die bonder operating method.

### DESCRIPTION OF RELATED ART

A die bonder, which is one of semiconductor manufacturing devices, performs bonding of a semiconductor chip (die) to a substrate such as a lead frame. In the die bonder, a bonding head vacuum-sucks a die, then moves upward, then horizontally moves, then moves downward, and bonds the die to the substrate, at a high speed. In such case, a part for up and down movement is an elevation (Z) drive axis.

Recently, there is an increasing need for high-accuracy and high-speed die bonder, and particularly, there is an increasing need for high-speed bonding head as the heart of bonding.

As a conventional bonding head driving method, driving a ball screw with a servo motor is known (Japanese Published Unexamined Patent Application No. 2004-263825).

### SUMMARY OF THE INVENTION

However, in the method of driving a ball screw with a servo motor, high-speed driving is limited. Accordingly, driving with a linear motor appropriate to high speed driving is studied. When a linear motor driving is merely adopted, the elevation axis can be easily manually-operated upon loss of power. As shown in FIG. 4B, in some cases, the bonding head as a handling part falls on a substrate (processing subject) such as a lead frame, and the bonding head is broken, and further, the substrate, i.e., the product is also broken.

Accordingly, the present invention has been made in consideration of the above situation, and provides a highly reliable biaxial drive mechanism including an elevation axis and a highly reliable die bonder using the biaxial drive mechanism and a die bonder operating method capable of preventing fall of elevation axis of a linear motor upon loss of power.

To attain the above-described object, the present invention has at least the following features.

According to the present invention, the first feature of the present invention is a biaxial drive mechanism comprising: a handling part; a biaxial drive axes provided with a first linear motor unit having a first movable part that moves up and down the handling part along a first linear guide and a first stationary part, and a second linear motor unit having a second movable part that moves the handling part in a horizontal direction vertical to a direction of up and down movement and a second stationary part; a main power source that supplies a power source to the biaxial drive axes; and an elevation axis fall prevention unit that prevents fall of a movable part of a handling part upon loss of power at the main power source.

Further, the second feature of the present invention is that the biaxial drive axes has: a connecting part that connects the first movable part via the first linear guide and connects the second movable part directly or indirectly; a second linear guide that moves the first movable part, the second movable part and the connecting part integrally in the horizontal direction; and a support body that fixes the first stationary part and the second stationary part with a predetermined length in parallel to each other in the horizontal direction.

Further, the third feature of the present invention is that the biaxial drive axes has a third linear guide that fixes the first linear motor unit to the second movable part, and guides movement of the first linear motor unit in the horizontal direction.

Further, the fourth feature of the present invention is that the elevation axis fall prevention unit has: a stopper provided on a first movable body to move along with the first movable part; and a support drive part that supports the stopper in a predetermined position upon loss of power.

Further, the fifth feature of the present invention is that the support drive part is provided on the first stationary part, otherwise, the support drive part is provided on both end sides of the second stationary part or other stationary part around the second stationary part.

Further, the sixth feature of the present invention is that the support drive part is a solenoid having a bar to be able to protrude in accordance with presence/absence of power source or an air cylinder having a cylinder rod.

Further, the seventh feature of the present invention is that a supporting operation to support in the predetermined position is performed with another power source provided in addition to the main power source.

Further, the eighth feature of the present invention is that a controller that moves up the first movable part or maintains the first movable part in its current status with another power source provided in addition to the main power source upon loss of power is provided.

Further, the ninth feature of the present invention is that the biaxial drive mechanism in the first to eighth features is provided, and the handling part performs processing on a substrate.

Further, the tenth feature of the present invention is that the handling part is a bonding head that picks up a die from a wafer and bonds the die to the substrate, or a needle that applies a die adhesive to the substrate.

Further, the eleventh feature of the present invention is comprising: providing a main power source; a step of moving up a bonding head with a linear motor unit by supply of a main power source to pick up a die and bond the die to a substrate; and a fall prevention step of upon loss of power at the main power source, preventing fall of the bonding head.

In accordance with the present invention as described above, it is possible to provide a highly reliable biaxial drive mechanism including an elevation axis and a highly reliable die bonder using the biaxial drive mechanism and a die bonder operating method capable of preventing fall of elevation axis of a linear motor upon loss of power.

### BRIEF DESCRIPTION OF THE DRAWINGS

The above and other object, features and advantages of the present invention will become more apparent from the following detailed description when taken in conjunction with the accompanying drawings wherein:

FIG. 1 is a conceptual diagram showing a die bonder according to a first embodiment of the present invention viewed from an upper position;

FIG. 2 is an A-A cross sectional diagram showing a basic structure of a ZY drive axes according to a first embodiment, and a first embodiment of an elevation axis fall prevention unit, in a position in FIG. 1 in which a bonding head on the ZY drive axes exists;

FIG. 3 illustrates the ZY drive axes shown in FIG. 2 viewed from an arrow B direction;

FIGS. 4A and 4B illustrate statuses of the bonding head upon loss of power;

FIG. 5 is a conceptual diagram showing the die bonder according to a second embodiment of the present invention viewed from an upper position;

FIGS. 6A and 6B illustrate the basic structure of the ZY drive axes and the elevation axis fall prevention unit according to the second embodiment;

FIG. 7 illustrates a status of the elevation axis fall prevention unit according to the second embodiment upon loss of power;

FIGS. 8A and 8B illustrate other positions than a position in which a solenoid is provided in the elevation axis fall prevention unit according to the first and second embodiments;

FIGS. 9A to 9C illustrate the elevation axis fall prevention unit according to a third embodiment;

FIGS. 10A and 10B illustrate the elevation axis fall prevention unit according to a fourth embodiment;

FIG. 11 illustrates a status of the elevation axis fall prevention unit according to the fourth embodiment upon loss of power; and

FIGS. 12A and 12B illustrate the elevation axis fall prevention unit according to a fifth embodiment.

### DETAILED DESCRIPTION OF THE PREFERRED EMBODIMENTS

Hereinbelow, preferred embodiments of the present invention will now be described in accordance with the accompanying drawings.

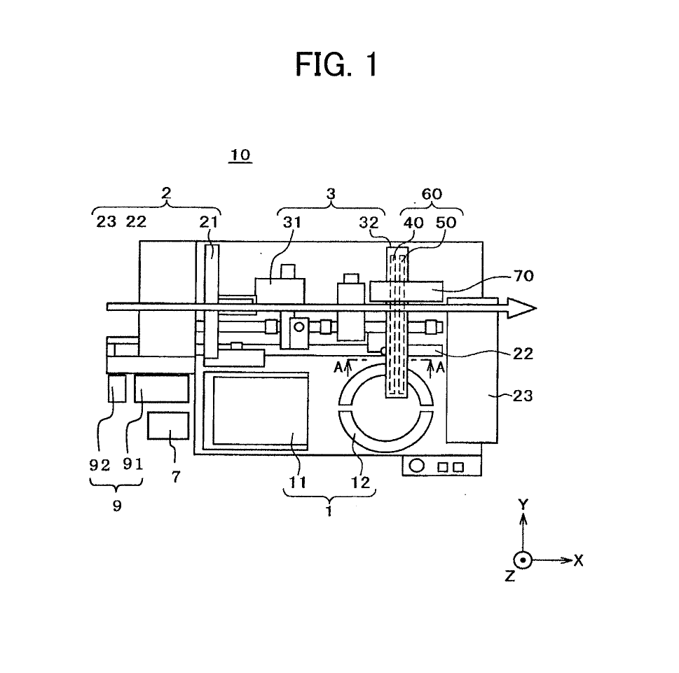

FIG. 1 is a conceptual diagram showing a die bonder 10 according to a first embodiment of the present invention viewed from an upper position. The die bonder 10 briefly has a wafer supply unit 1, a work supply-conveyance unit 2, a die bonding unit 3, a power source unit 9, and a controller 7 to control these units.

The wafer supply unit 1 has a wafer cassette lifter 11 and a pickup device 12. The wafer cassette lifter 11, having a wafer cassette (not shown) filled with wafer rings, sequentially supplies the wafer rings to the pickup device 12. The pickup device 12 moves the wafer ring so as to pick up a desired die from the wafer ring.

The work supply-conveyance unit 2 has a stack loader 21, a frame feeder 22 and an unloader 23. The work supply-conveyance unit 2 conveys a work (a substrate such as a lead frame) in an arrow direction. The stack loader 21 supplies a work, to which die is bonded, to the frame feeder 22. The frame feeder 22 conveys the work via two processing positions on the frame feeder 22 to the unloader 23. The unloader 23 stores the conveyed work.

The die bonding unit 3 has a preform unit (die paste applicator) 31 and a bonding head unit 32. The preform unit 31 applies a die adhesive to the work conveyed with the frame feeder 22 such as a lead frame with a needle. The bonding head unit 32 picks up the die from the pickup device 12 then moves upward, and horizontally moves the die to a bonding point above the frame feeder 22. Then the bonding head 32 moves down the die at the bonding point, and bonds the die to the work on which the die adhesive is applied.

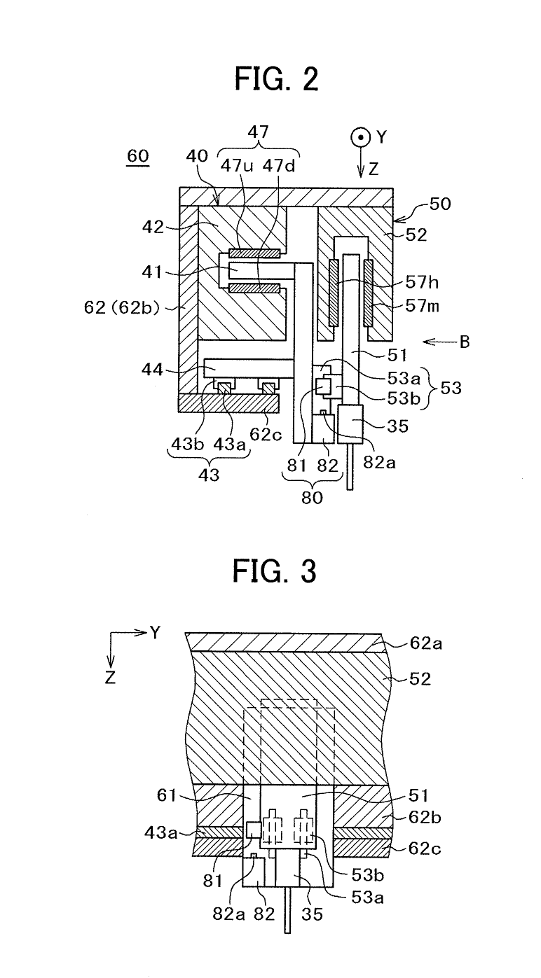

The bonding head unit 32 has a ZY drive axes 60 to elevate the bonding head 35 (see FIG. 2) in a Z (height) direction then horizontally move the bonding head 35 in a Y direction, and an X drive axis 70 to horizontally move the bonding head 35 in an X direction. The ZY drive axes 60 has a Y drive axis 40 to move the bonding head 35 in the Y direction, i.e., between a pickup position in the wafer ring holder 12 and the bonding point, and a Z drive axis 50 to move the bonding head 35 upward to pick up the die from the wafer or for bonding on the substrate. The X drive axis 70 moves the entire ZY drive axes 60 in the X direction to convey the work. The X drive axis 70 may drive a ball screw with a servo motor or with a liner motor to be described in the structure of the ZY drive axes 60.

The power source unit 9 has a main power source 91 used in normal packaging processing and another battery 92 as a power source different from the main power source, necessary for prevention of fall of an elevation axis to be described later in detail.

FIGS. 2 and 3 illustrate a basic structure of the ZY drive axes 60 according to the first embodiment and the elevation axis fall prevention unit according to the first embodiment. FIG. 2 is an A-A cross sectional diagram in FIG. 1 showing the bonding head 35 existing at the end of the ZY drive axes 60. FIG. 3 illustrates the ZY drive axes 60 shown in FIG. 2 viewed from an arrow B direction.

First, the ZY drive axes 60 including the elevation axis according to the first embodiment as a feature of the present invention will be described using the drawings.

The ZY drive axes 60 according to the first embodiment has a Y drive axis 40, a Z drive axis 50, a connecting part 61 to connect a Y axis movable part 41 of the Y drive axis 40 and a Z axis movable part 51 of the Z drive axis 50, the bonding head 35 as a handling part, an elevation axis fall prevention unit 80 to prevent fall of the bonding head 35 upon loss of power, and an L-shaped support body 62 to support the entire ZY drive axes 60. Note that for assistance of understanding of the following explanation, a part fixed to the support body 62 is diagonally hatched, while a part to move integrally with the Y axis movable part 41, the X axis movable part 51 and the connecting part 61 are represented in outline. Further, the support body 62 has an upper support body 62a, a side support body 62b and a lower support body 62c.

The Y drive axis 40 has a C-shaped Y axis stationary part 42 having upper and lower stationary electromagnets 47u and 47d in which a large number of N pole and S pole electromagnets are alternately arrayed in the Y direction (hereinafter, when the electromagnets are generally referred to or any position is not designated, simply denoted by “47”), the Y axis movable part 41, having at least a pair of N pole and S pole electromagnets in the array direction, which is inserted in a C-shaped concave part and moved in the concave part, the connecting part 61 to support the Y axis movable part 41, and a Y axis guide part 44 which is fixed to the connecting part 61, and which has a Y axis linear guide 43 provided between the Y axis guide part and the lower support body 62c. The Y axis stationary part 42 is provided over approximately the whole area of the Y drive axis 40 indicated with a broken line in FIG. 1 such that the Y axis movable part 41 can move in a predetermined range. Further, the Y axis linear guide 43 has two linear rails 43a extending in the Y direction and a linear slider 43b to move on the linear rails.

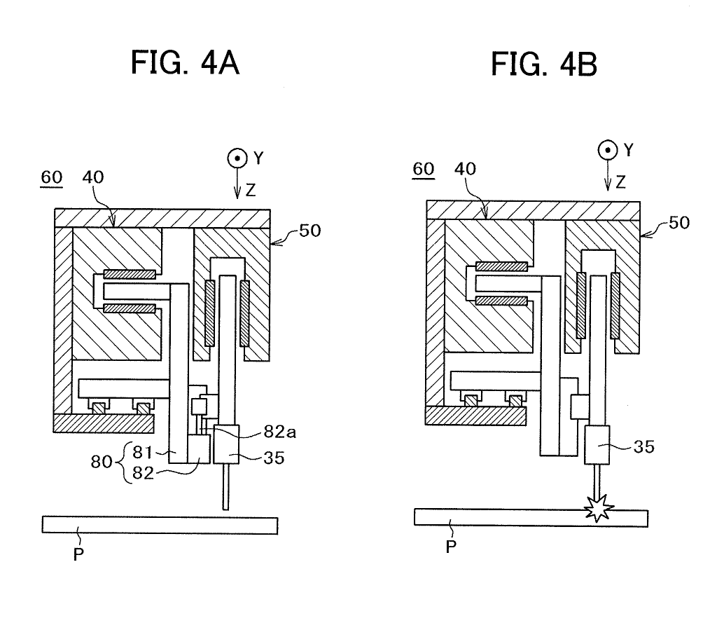

As in the case of the Y drive axis 40, the Z drive axis 50 has a U-shaped Z axis stationary part 52 having right and left stationary electromagnets 57h and 57m in which a large number of N pole and S pole electromagnets are alternately arrayed in the Z direction (see FIG. 4. Hereinafter, when the electromagnets are generally referred to or any position is not designated, simply denoted by “57”), the Z axis movable part 51, having at least a pair of N pole and S pole electromagnets in the array direction of the Z axis stationary part 52 in an upper part, which is inserted in a U-shaped concave part and moved in the concave part, and a Z axis linear guide 53 having a similar structure to that of the Y axis linear guide 43 between the Z axis movable part 51 and the connecting part 61. The Z axis linear guide 53 has two linear rails 53a fixed to the connecting part 61 and expanding in the Z direction and a linear slider 53b which is fixed to the Z axis movable part 51 and which moves on the linear rails.

The Z axis movable part 51 is connected via the connecting part 61 to the Y axis movable part 41. When the Y axis movable part 41 horizontally moves in the Y direction, the Z axis movable part 51 also horizontally moves in the Y direction. It is necessary to provide N pole and S pole electromagnets in at least moving destination predetermined positions, e.g., a bonding region and a pickup region, such that the Z axis movable part 51 (bonding head 35) moves up and down. Note that a part to move up and down integrally with the Z axis movable part 51 is referred to as a Z axis movable body.

Next, the elevation axis fall prevention unit 80 according to the first embodiment as one of the characteristic features of the present invention will be described with reference to FIGS. 2, 3 and FIGS. 4A and 4B. FIGS. 4A and 4B illustrate statuses of the bonding head 35 upon loss of power. FIG. 4A illustrates a status when the elevation axis fall prevention unit 80 is provided; and FIG. 4B, a status when the elevation axis fall prevention unit 80 is not provided.

The elevation axis fall prevention unit 80 according to the first embodiment has a stopper 81 fixed to the linear slider 53b to move up/down the bonding head 35, a pusher solenoid 82 as a support drive part fixed to the connecting part 61 as shown in FIG. 3, in which a protrusion part of a push bar 82a is prolonged upon loss of power so as to support the stopper 81, and another power source 92 shown in FIG. 1.

In the elevation axis fall prevention unit 80 having the above structure, the controller 7 detects loss of the main power source 91 upon loss of power, connects the other power source 91 to the pusher solenoid 82 while the power source is maintained with a capacitor or the like, and supplies the power source.

As a result, as shown in FIG. 4A, the pusher solenoid 82 is activated, then the push bar 82a is protruded, to support the stopper 81, to prevent fall of the bonding head 35 on a substrate P.

According to the above-described first embodiment of the elevation axis fall prevention unit 80 of the present invention, upon loss of power at the main power source 91, it is possible to activate the pusher solenoid with another power source so as to prevent fall of the bonding head having the elevation axis of the linear motor.

As a result, it is possible to prevent breakage of the bonding head and the substrate.

Further, according to the above-described first embodiment of the ZY drive axes 60 in the invention, the Z axis stationary part 52 is provided in approximately the whole region, but the Z axis stationary part 52 is a heavy body and the Z axis stationary part 52 itself does not move. Accordingly, the load on the movement in the Y direction is greatly reduced, and it is possible to realize a high-speed elevation axis without increment in torque on a horizontal drive axis.

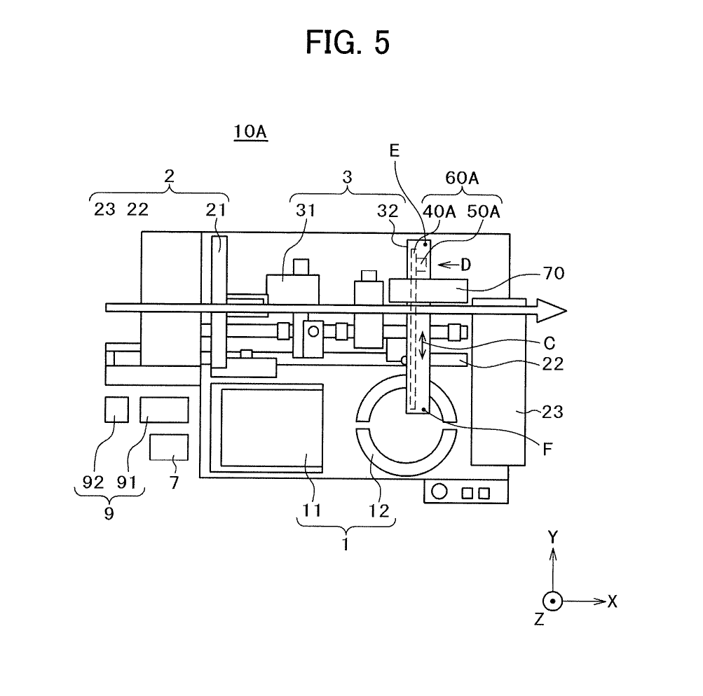

Next, FIG. 5 is a conceptual diagram showing the die bonder 10A according to a second embodiment of the present invention viewed from an upper position. The difference between the die bonder 10 according to the first embodiment and the die bonder 10A according to the second embodiment is that the ZY drive axes and the elevation axis fall prevention unit are different. The other elements are basically the same as those in the first embodiment. In the second embodiment, the constitute elements having basically the same structures or functions as those in the first embodiment have the same reference numerals.

In a ZY drive axes 60A according to the second embodiment, a Z drive axis 50A is basically different from the ZY drive axes 60 according to the first embodiment. In the ZY drive axes 60 according to the first embodiment, the Z axis stationary part 52 of the Z drive axis 50 as an elevation axis is provided in the whole region of the moving range as in the case of the Y axis stationary part 42. The Z axis movable part 51 moves integrally with the Y axis movable part 41.

On the other hand, in the Z drive axis 50A according to the second embodiment, Z axis stationary part 52A and the Z axis movable part 51A move integrally with the Y axis movable part 41A in an arrow C direction in FIG. 5. The shapes of the Y axis stationary part 42A and the Y axis movable part 41A forming the Y drive axis 40A according to the second embodiment, the connection direction of the Z drive axis 50A to the Y drive axis 40A are different from those in the first embodiment, however, the basic structural functions are the same.

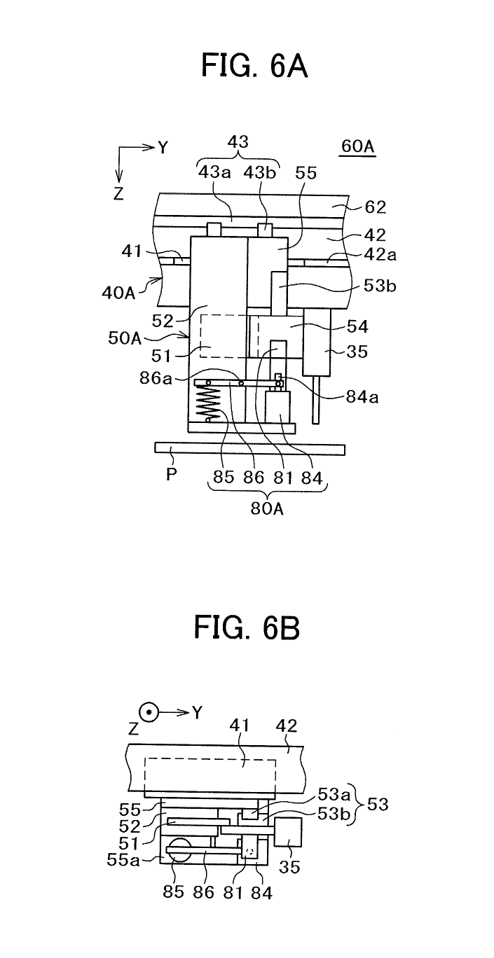

FIGS. 6A and 6B illustrate the basic structure of the ZY drive axes and the elevation axis fall prevention unit according to the second embodiment. FIG. 6A illustrates the ZY drive axes 60A viewed from an arrow D direction in a position where the bonding head 35 exists in FIG. 5. FIG. 6B illustrates the ZY drive axes 60A shown in FIG. 6A viewed from an upper direction. Note that in FIG. 6B, the support body 62 and the Y axis linear guide 43 shown in FIG. 6A are omitted. Further, in FIGS. 6A and 6B, the stationary electromagnets 47 and 57 in FIGS. 2 and 3 are omitted.

The ZY drive axes 60A according to the second embodiment has the Y drive axis 40A, the Z drive axis 50A, the bonding head 35 as a handling part, an elevation axis fall prevention unit 80A to prevent fall of the bonding head 35 upon loss of power, and the support body 62 to support these elements.

As in the case of the first embodiment, the Y drive axis 40A has the C-shaped Y axis stationary part 42 which is fixed to the support body 62 and which has an opening 42a on the front side, and the Y axis movable part 41 which is inserted from the opening 42a in the concave part of the Y axis stationary part 42 and which moves in the concave part. The Y axis stationary part 42 is provided over approximately the whole region of the Y drive axis 40A indicated with a broken line in FIG. 5 such that the Y axis movable part 41 can move within a predetermined range.

As in the case of the Y drive axis 40A, the Z drive axis 50A has the C-shaped Z axis stationary part 52, the Z axis movable part 51 which is inserted in the C-shaped concave part and which moves in the concave part, a connecting part 54 to connect the Z axis movable part 51 and the bonding head 35, the Z axis linear guide 53 to guide up and down movement of the bonding head 35 in accordance with up and down movement of the Z axis movable part 51A, a holding body 55 to fix and hold these elements, and the Y axis linear guide 43 to guide the entire horizontal movement of the holding body 55, i.e. the Z drive axis 50A in accordance with the horizontal movement of the Y axis movable part 41 in the Y direction. The Z axis linear guide 53 has linear rails 53a fixed to the holding body 55, and a linear slider 53b which is fixed with the connecting part 54 and which moves up and down above the linear rails 53a. Further, the Y axis linear guide 43 has a linear rail 43a fixed with the support body 62 and the linear slider 43b to horizontally move on the linear rail 43a. Note that as in the case of the first embodiment 60 of the ZY drive axes, a part which moves integrally with the Z axis movable part 51 will be referred to as a “Z axis movable body”.

Next, the elevation axis fall prevention unit 80A according to the second embodiment as one of the characteristic features of the present invention will be described. The elevation axis fall prevention unit 80A has the stopper 81 fixed to the connecting part 54, a pull solenoid 84, fixed to the bottom of the holding body 55 and supplied with power from the main power source, which always pulls a pull bar 84a, a spring 85 fixed to the bottom of the holding body 55, and an actuation bar 86 with one end connected to the pull bar 84a and the other end connected to the spring 85. In the present embodiment, the support drive part has the pull solenoid 84, the spring 85 and the actuation bar 86. Note that the pull solenoid 84 is fixed to a bottom 55a of the holding body 55, and a supporting point 86a of the actuation bar 86 is fixed to the Y axis movable part 52.

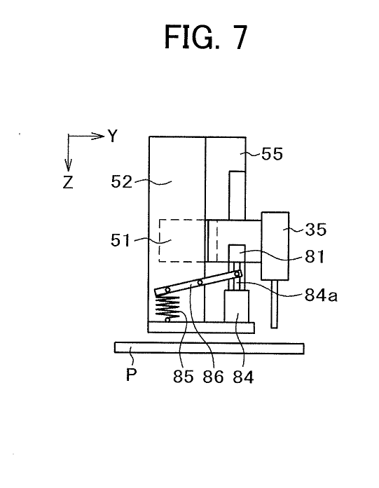

In the elevation axis fall prevention unit 80A having the above structure, upon loss of power as shown in FIG. 7, the pull bar 84a of the pull solenoid 84 becomes free, the pull bar 84a is protruded with the spring 85, to support the stopper 81, thus fall of the bonding head 35 on the substrate can be prevented. In the present embodiment, another power source is unnecessary. Note that in FIG. 7, the Y drive axis 40A and the support body 62 are omitted.

According to the above-described second embodiment of the elevation axis fall prevention unit, upon loss of power at the main power source 91, it is possible to actuate the pull solenoid even without another power source and prevent fall of the bonding head having an elevation axis of a linear motor.

As a result, also in the second embodiment of the elevation axis fall prevention unit, it is possible to prevent breakage of the bonding head and the substrate.

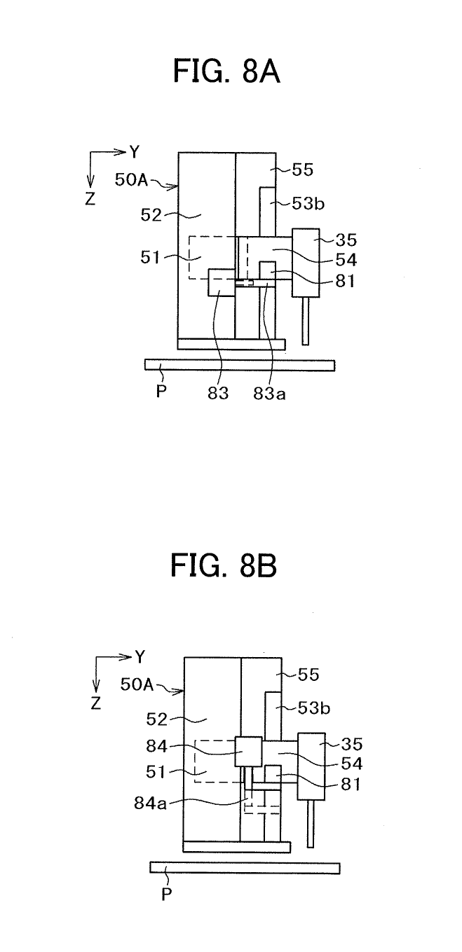

In the above-described first and second embodiments, the pusher solenoid 82 and the pull solenoid 84 are arranged below the stopper 81, however, as shown in FIG. 8, they may be fixedly arranged askance in the Z axis drive unit 52 according to the second embodiment or the holding body 55 (FIG. 8A), or may be fixedly arranged upward (FIG. 8B). In FIGS. 8A and 8B, a normal status in packaging processing without loss of power is indicated with a broken line, while that upon loss of power, with a solid line. In FIG. 8A, upon loss of power, a pusher bar 82a of the pusher solenoid 82 is projected, to support the stopper 81. In FIG. 8B, upon loss of power, the pull bar 84a of the pull solenoid 84 is sucked, to support the stopper 81. Another power source is required in the examples in FIGS. 8A and 8B.

Further, the position of the stopper 81 is not limited to the positions shown in FIGS. 2 and 6, but may be any position as long as the stopper moves up/down along with the bonding head 35. The stopper position is similarly set in other embodiments. Further, the solenoid is not limitedly used but an air cylinder may be used as long as necessary response can be ensured.

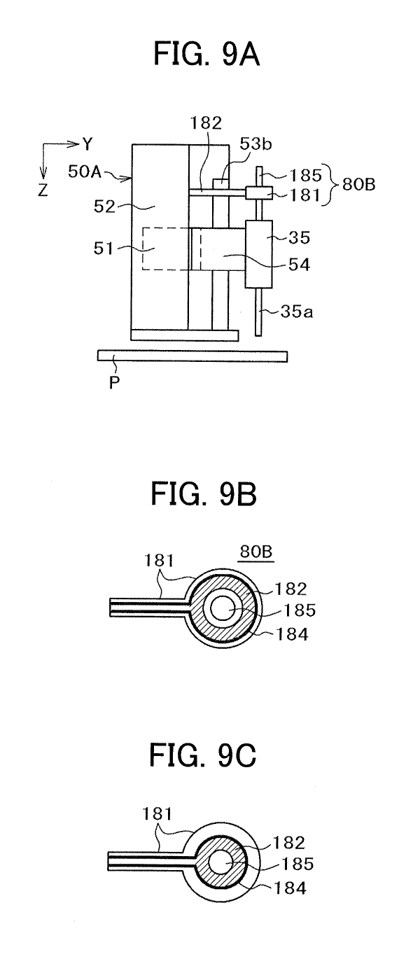

Next, an elevation axis fall prevention unit 80B according to a third embodiment as one of the characteristic feature of the present invention will be described with reference to FIGS. 9A to 9C. FIG. 9A illustrates elevation axis fall prevention unit 80B according to the third embodiment provided on the ZY drive axis 60A according to the second embodiment. FIG. 9B illustrates a status of the elevation axis fall prevention unit 80B without loss of power, and FIG. 9C, a status of the elevation axis fall prevention unit 80B upon loss of power. Note that in FIG. 9A, the Y drive axis 40A and the support body 62 are omitted.

The elevation axis fall prevention unit 80B has a hollow case 181 having a ring-shaped hollow part with one end fixed to the Z axis stationary part 52 and with the inner periphery of the other end opened, an incombustible elastic body (e.g. rubber) 182 provided at least in the ring-shaped hollow part, a shape memory alloy 184 provided on the periphery of the elastic body 182, and a brake rod 185 as a projection part provided on the upper side of the bonding head 35. Note that as the projection part, a suction nozzle 35a provided at the end of the bonding head 35 in place of the brake rod may be used.

In the shape memory alloy 184, when power is supplied from the main power source 91 and an electric current flows through the shape memory alloy, a shape to maintain the elastic body 182 away from the brake rod 185 as shown in FIG. 9B is memorized. On the other hand, upon loss power, when the electric current does not flow, the radius of the shape memory alloy 184 is reduced as shown in FIG. 9C. As a result, upon loss of power, the shape memory alloy 184 compresses the elastic body 182, and the elastic body 182 applies a brake to the brake rod 185, to prevent fall of the bonding head 35. In the present embodiment, the other power source 92 is not necessary. Note that when an inverse shape is memorized in the shape memory alloy 184, the other power source 92 is necessary.

In the above-described elevation axis fall prevention unit 80B according to the third embodiment, similar advantages to those in the first and second embodiments can be obtained.

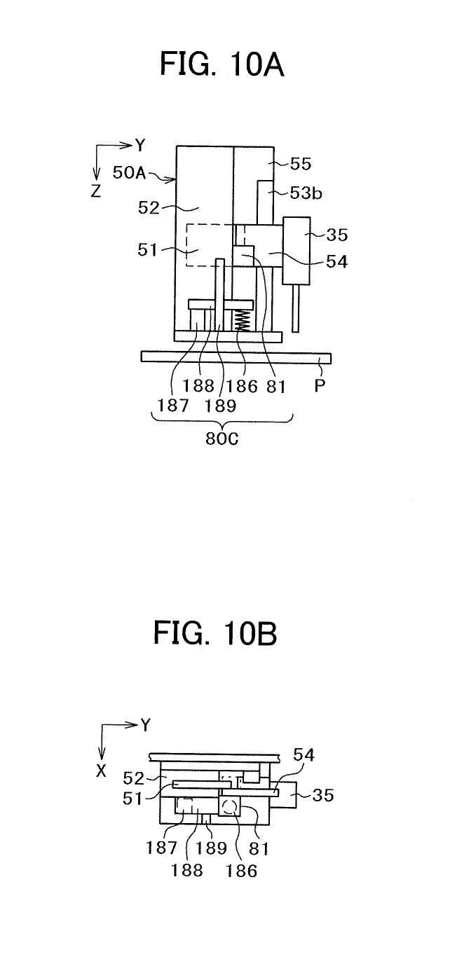

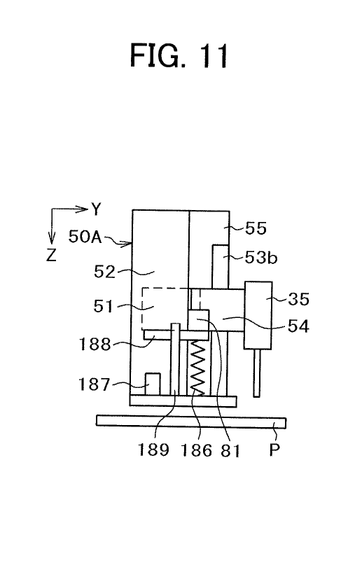

Next, an elevation axis fall prevention unit 80C according to a fourth embodiment as one of the characteristic features of the present invention will be described with reference to FIGS. 10A and 10B. FIGS. 10A and 10B illustrate the Z drive axis 50A according to the second embodiment and the elevation axis fall prevention unit 80C according to the third embodiment provided on the Z drive axis 50A. FIG. 10A illustrates the ZY drive axes 60A in the position where the bonding head 35 exists in FIG. 5, viewed from an arrow D direction, in a normal status without loss of power. FIG. 10B illustrates the ZY drive axes 60A shown in FIG. 10A viewed from an upper direction. FIG. 11 illustrates a status of the elevation axis fall prevention unit 80C upon loss of power.

The elevation axis fall prevention unit 80C in the fourth embodiment has a spring 186, an electromagnet 187, a support drive part with one end fixed to the spring 186 while the other end provided with an actuation plate 188 as an actuation part attracted to the electromagnet 187 and a guide rod 189 to guide up and down movement of the actuation plate 188 along with the Z axis stationary part 52, and the stopper 81.

When power is supplied from the main power source 91 and the electric current flows through the shape memory alloy, the actuation plate 188 is attracted to the electromagnet 187 as shown in FIG. 10A, thus the status where the spring 186 is compressed is maintained. On the other hand, upon loss of power and the electric current does not flow, the actuation plate 188 is released and the spring 186 is expanded as shown in FIG. 11. As a result, the actuation plate 188 supports the connecting part 54, thus fall of the bonding head 35 can be prevented.

In the above-described elevation axis fall prevention unit 80B in the fourth embodiment, similar advantages to those in the first to third embodiments can be obtained.

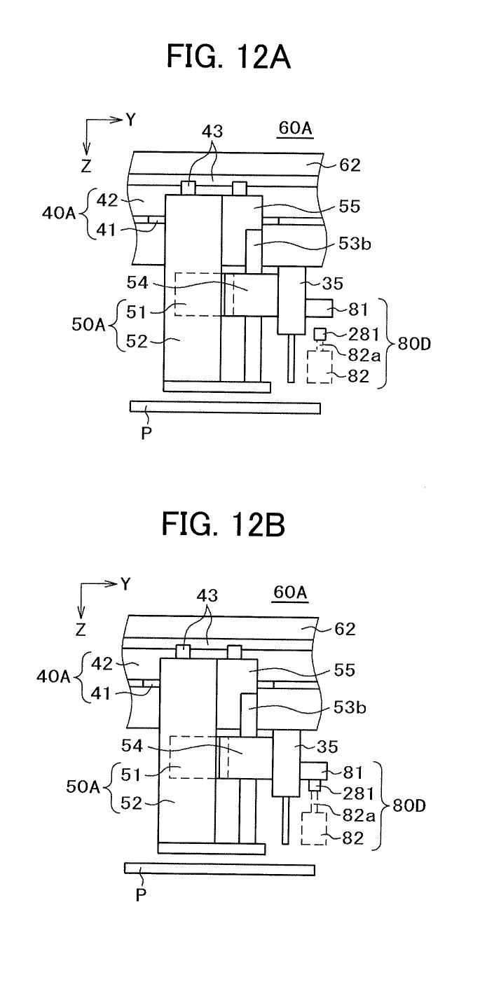

Next, an elevation axis fall prevention unit 80D according to a fifth embodiment as one of the characteristic features of the present invention will be described with reference to FIGS. 12A and 12B. FIGS. 12A and 12B illustrate the elevation axis fall prevention unit 80D according to the fifth embodiment provided in place of the elevation axis fall prevention unit 80A according to the second embodiment shown in FIGS. 6A and 6B, on the ZY drive axes 60A. FIG. 12A illustrates a normal status without loss of power, and FIG. 12B, a status upon loss of power.

The elevation axis fall prevention unit 80D is fixed to the Y axis fixing unit or the support body 62 or a fixing part around these parts in positions E or F shown in FIG. 5. The elevation axis fall prevention unit 80D has two pusher solenoids 82 provided in the positions E and F in which the protrusion part of a push bar 82a is prolonged upon loss of power in the elevation axis fall prevention unit 80 according to the first embodiment, an actuation rod 281 as an actuation part with both ends fixed to the end of the two push bars 82a, and the stopper 81 fixed to the side of the bonding head 35 on the opposite side to the connecting part 54. In the present embodiment, the support drive part has the two pusher solenoids 82 and the actuation rod 281.

As shown in FIG. 12B, in the elevation axis fall prevention unit 80D, upon loss of power, the two push bars 82a are protruded, to push up the actuation rod 281, to support the stopper 81, thus fall of the bonding head 35 can be prevented, as in the case of the elevation axis fall prevention unit 80.

As described above, the elevation axis fall prevention unit 80D according to the fifth embodiment, different from the first to fourth embodiments, is provided not on the Z drive parts 40 and 40A but on the Y axis fixing part or the support body 62 or a fixing part around these parts. Further, as the actuation of the actuation rod 281, the methods shown in the second to fourth embodiments are applicable.

According to the above-described elevation axis fall prevention unit 80D according to the fifth embodiment, as the elevation axis fall prevention unit is not provided in the Z drive parts 40 and 40A, the structure of the Z drive part can be simplified.

Further, according to the above-described elevation axis fall prevention unit 80D according to the fifth embodiment, fall of the bonding head 35 can be prevented as in the case of the other embodiments.

Finally, an elevation axis fall prevention unit 80E according to a sixth embodiment as one of the characteristic features of the present invention will be described.

In the elevation axis fall prevention unit 80E according to the sixth embodiment, upon loss of power, a controller 9 controls e.g. the stationary electromagnet 57 shown in FIG. 2 with the other power source 92, to move up the bonding head 35 (Z axis movable part 52) or maintain that status, to hold the bonding head 35 in a predetermined position.

According to the sixth embodiment of the elevation axis fall prevention unit, it is possible to prevent fall of the bonding head 35 without any new mechanism other than the other power source 92.

In the above description, the bonding head is used as a handling part. Basically, the bonding head is applicable to a handling part requiring a biaxial drive mechanism having an elevation axis. For example, in a die bonder, it is applicable to a needle to apply a die adhesive to a substrate.

The embodiments of the present invention have been described as above, however, various alternatives, modifications and equivalents can be made by those skilled in the art based on the above description, and it is intended for the subject matter of the invention to include all alternatives, modifications and equivalents within the spirit and scope of the following claims.

1. A biaxial drive mechanism comprising:
a handling part;
a biaxial drive axes provided with a first linear motor unit having a first movable part that moves up/down the handling part along a first linear guide and a first stationary part, and a second linear motor unit having a second movable part that moves the handling part in a horizontal direction vertical to a direction of up and down movement and a second stationary part;
a main power source that supplies a power source to the biaxial drive axes; and
an elevation axis fall prevention unit that prevents fall of a movable part of a handling part upon loss of power at the main power source.

2. The biaxial drive mechanism according to claim 1, wherein the biaxial drive axes has:
a connecting part that connects the first movable part via the first linear guide and connects the second movable part directly or indirectly;
a second linear guide that moves the first movable part, the second movable part and the connecting part integrally in the horizontal direction; and
a support body that fixes the first stationary part and the second stationary part with a predetermined length in parallel to each other in the horizontal direction.

3. The biaxial drive mechanism according to claim 1, wherein the biaxial drive axes has a third linear guide that fixes the first linear motor unit to the second movable part, and guides movement of the first linear motor unit in the horizontal direction.

4. The biaxial drive mechanism according to claim 2, wherein the elevation axis fall prevention unit has:
a stopper provided on a first movable body to move along with the first movable part; and
a support drive part that supports the stopper in a predetermined position upon loss of power.

5. The biaxial drive mechanism according to claim 3, wherein the elevation axis fall prevention unit has:
a stopper provided on a first movable body to move along with the first movable part; and
a support drive part that supports the stopper in a predetermined position upon loss of power.

6. The biaxial drive mechanism according to claim 4, wherein the support drive part is provided on the first stationary part, otherwise, the support drive part is provided on both end sides of the second stationary part or other stationary part around the second stationary part.

7. The biaxial drive mechanism according to claim 5, wherein the support drive part is provided on the first stationary part, otherwise, the support drive part is provided on both end sides of the second stationary part or other stationary part around the second stationary part.

8. The biaxial drive mechanism according to claim 5, wherein the support drive part is a solenoid having a bar or an air cylinder having a cylinder rod to protrude in accordance with presence/absence of power source.

9. The biaxial drive mechanism according to claim 6, wherein the support drive part is a solenoid having a bar or an air cylinder having a cylinder rod to protrude in accordance with presence/absence of power source.

10. The biaxial drive mechanism according to claim 4, wherein the support drive part is provided on the first stationary part,
and wherein the support drive part has an elastic body provided so as to surround a projection on the handling part or provided on the handling part, and a contracting means to contract the elastic body.

11. The biaxial drive mechanism according to claim 8, wherein a supporting operation to support in the predetermined position is performed with another power source provided in addition to the main power source.

12. The biaxial drive mechanism according to claim 9, wherein a supporting operation to support in the predetermined position is performed with another power source provided in addition to the main power source.

13. The biaxial drive mechanism according to claim 6, wherein the support drive part has:
a solenoid having a bar to be able to protrude upon loss of power;
a spring; and
an actuation unit that connects the bar and the spring, see-saw rotates about a supporting point, and protrudes the bar with the spring upon loss of power.

14. The biaxial drive mechanism according to claim 7, wherein the support drive part has:
a solenoid having a bar to be able to protrude upon loss of power;
a spring; and
an actuation unit that connects the bar and the spring, see-saw rotates about a supporting point, and protrudes the bar with the spring upon loss of power.

15. The biaxial drive mechanism according to claim 6, wherein the support drive part has:
a solenoid having a bar to be able to protrude with another power source provided in addition to the main power source;
an electromagnet; and
an actuation unit attracted to the electromagnet by supply of the main power source and connected to the bar.

16. The biaxial drive mechanism according to claim 7, wherein the support drive part has:
a solenoid having a bar to be able to protrude with another power source provided in addition to the main power source;
an electromagnet; and
an actuation unit attracted to the electromagnet by supply of the main power source and connected to the bar.

17. The biaxial drive mechanism according to claim 2, further comprising a controller that moves up the first movable part or maintains the first movable part in its current status with another power source provided in addition to the main power source upon loss of power.

18. The biaxial drive mechanism according to claim 3, further comprising a controller that moves up the first movable part or maintains the first movable part in its current status with another power source provided in addition to the main power source upon loss of power.

19. A die bonder having the biaxial drive mechanism in claim 1, wherein the handling part performs processing on a substrate,
and wherein the handling part is a bonding head that picks up a die from a wafer and bonds the die to the substrate, or a needle that applies a die adhesive to the substrate.

20. A die bonder having the biaxial drive mechanism in claim 2, wherein the handling part performs processing on a substrate,
and wherein the handling part is a bonding head that picks up a die from a wafer and bonds the die to the substrate, or a needle that applies a die adhesive to the substrate.

21. A die bonder having the biaxial drive mechanism in claim 3, wherein the handling part performs processing on a substrate,
and wherein the handling part is a bonding head that picks up a die from a wafer and bonds the die to the substrate, or a needle that applies a die adhesive to the substrate.

22. A die bonder having the biaxial drive mechanism in claim 4, wherein the handling part performs processing on a substrate,
and wherein the handling part is a bonding head that picks up a die from a wafer and bonds the die to the substrate, or a needle that applies a die adhesive to the substrate.

23. A die bonder having the biaxial drive mechanism in claim 5, wherein the handling part performs processing on a substrate,
and wherein the handling part is a bonding head that picks up a die from a wafer and bonds the die to the substrate, or a needle that applies a die adhesive to the substrate.

24. A die bonder having the biaxial drive mechanism in claim 6, wherein the handling part performs processing on a substrate,
and wherein the handling part is a bonding head that picks up a die from a wafer and bonds the die to the substrate, or a needle that applies a die adhesive to the substrate.

25. A die bonder having the biaxial drive mechanism in claim 7, wherein the handling part performs processing on a substrate,
and wherein the handling part is a bonding head that picks up a die from a wafer and bonds the die to the substrate, or a needle that applies a die adhesive to the substrate.

26. A die bonder having the biaxial drive mechanism in claim 8, wherein the handling part performs processing on a substrate,
and wherein the handling part is a bonding head that picks up a die from a wafer and bonds the die to the substrate, or a needle that applies a die adhesive to the substrate.

27. A die bonder having the biaxial drive mechanism in claim 9, wherein the handling part performs processing on a substrate,
and wherein the handling part is a bonding head that picks up a die from a wafer and bonds the die to the substrate, or a needle that applies a die adhesive to the substrate.

28. A die bonder having the biaxial drive mechanism in claim 11, wherein the handling part performs processing on a substrate,
and wherein the handling part is a bonding head that picks up a die from a wafer and bonds the die to the substrate, or a needle that applies a die adhesive to the substrate.

29. A die bonder having the biaxial drive mechanism in claim 13, wherein the handling part performs processing on a substrate,
and wherein the handling part is a bonding head that picks up a die from a wafer and bonds the die to the substrate, or a needle that applies a die adhesive to the substrate.

30. A die bonder having the biaxial drive mechanism in claim 15, wherein the handling part performs processing on a substrate,
and wherein the handling part is a bonding head that picks up a die from a wafer and bonds the die to the substrate, or a needle that applies a die adhesive to the substrate.

31. A die bonder having the biaxial drive mechanism in claim 16, wherein the handling part performs processing on a substrate,
and wherein the handling part is a bonding head that picks up a die from a wafer and bonds the die to the substrate, or a needle that applies a die adhesive to the substrate.

32. A die bonder having the biaxial drive mechanism in claim 18, wherein the handling part performs processing on a substrate,
and wherein the handling part is a bonding head that picks up a die from a wafer and bonds the die to the substrate, or a needle that applies a die adhesive to the substrate.

33. A die bonder operating method comprising:
a step of providing a main power source;
a step of moving up a bonding head with a linear motor by supply of a main power source to pick up a die and bond the die to a substrate; and
a fall prevention step of upon loss of power at the main power source, preventing fall of the bonding head.
